(19) United States
(12) Patent Application Publication
(10) Pub. No.: US 2026/0369718 A1
(43) Pub. Date: Nov. 19, 2026

(54) Battery Module

(71) Applicant: Nissan Motor Co., Ltd., Yokohama-shi, Kanagawa (JP)

(72) Inventors: Taewon Kim, Kanagawa (JP); Shinichiro Hidaka, Kanagawa (JP); Mingyu Kim, Kanagawa (JP); Sei Mizojiri, Kanagawa (JP); Bunsei Okabe, Kanagawa (JP); Hirokazu Komatsu, Kanagawa (JP); Kenzo Oshihara, Kanagawa (JP); Naohide Tsuji, Kanagawa (JP)

(21) Appl. No.: 19/136,712

(22) PCT Filed: Dec. 9, 2022
(86) PCT No.: PCT/JP2022/045508

§ 371 Date: Jun. 6, 2025

(51) Int. Cl. H01M 10/613; H01M 10/647; H01M 10/6553; H01M 10/6556; H01M 10/658

(52) U.S. Cl. CPC H01M 10/613; H01M 10/647; H01M 10/6553; H01M 10/6556; H01M 10/658

(57) ABSTRACT

A battery module includes a plurality of battery cells that are mutually stacked, a heat transfer member having an electric insulating property and covering peripheries of positive/negative electrode tabs of the plurality of battery cells, and a cooling jacket that has an internal space in which a coolant flows and is in contact with the heat transfer member.

### TECHNICAL FIELD

The present invention relates to a battery module.

### BACKGROUND

There has been a known electric storage device including a cell stack formed by stacking storage cells, a busbar connected to tabs of the storage cells, and a tubular flow passage formed along the busbar (see, for example, JP 2020-24886 A). The electric storage device circulates a heating medium through the flow passage for cooling or heating the busbar.

### SUMMARY

The above-described conventional storage cells, however, cause their busbar to have contact lines with the flow passage for cooling. The resultant heat transfer efficiency between the flow passage and the busbar becomes low, causing the problem of deterioration in the cooling efficiency of the battery cell.

An object of the present invention is to provide a battery module that allows improvement in the cooling efficiency of the battery cell.

The present invention solves the above-described problem by providing: a heat transfer member having an electric insulating property and being in direct contact with peripheries of the tabs of the plurality of battery cells to cover the peripheries of the tabs; and a cooling jacket having an internal space in which a coolant flows and in contact with the heat transfer member, and bringing the heat transfer member into direct contact with a distal end surface and a peripheral surface of the tabs.

According to the present invention, the peripheries of the tabs of the battery cells are covered with the heat transfer member, and the cooling jacket is brought into contact with the heat transfer member. This makes it possible to improve the heat transfer efficiency between the tabs and the heat transfer member, and further to improve the cooling efficiency of the battery cell.

### BRIEF DESCRIPTION OF THE DRAWINGS

FIG. 1 is a perspective view of an exemplary structure of a battery module according to an embodiment of the present invention;

FIG. 2 is a sectional view taken along the line II-II of FIG. 1;

FIG. 3 is a sectional view of an exemplary structure of a battery module according to a first modification;

FIG. 4 is a plan view illustrating an exemplary structure of a battery module according to a second modification; and

FIG. 5 is a plan view illustrating an exemplary structure of a battery module according to a third modification.

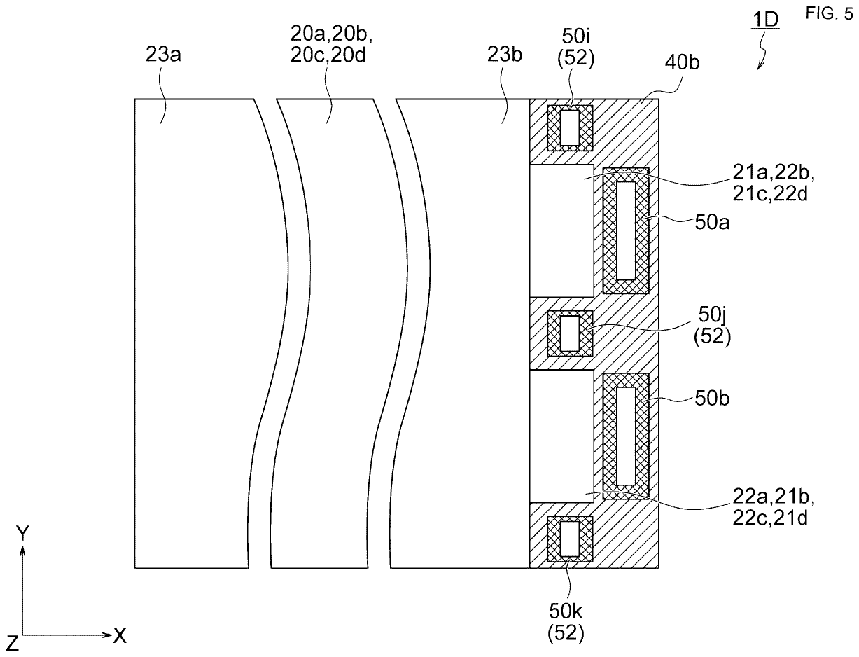

### DETAILED DESCRIPTION

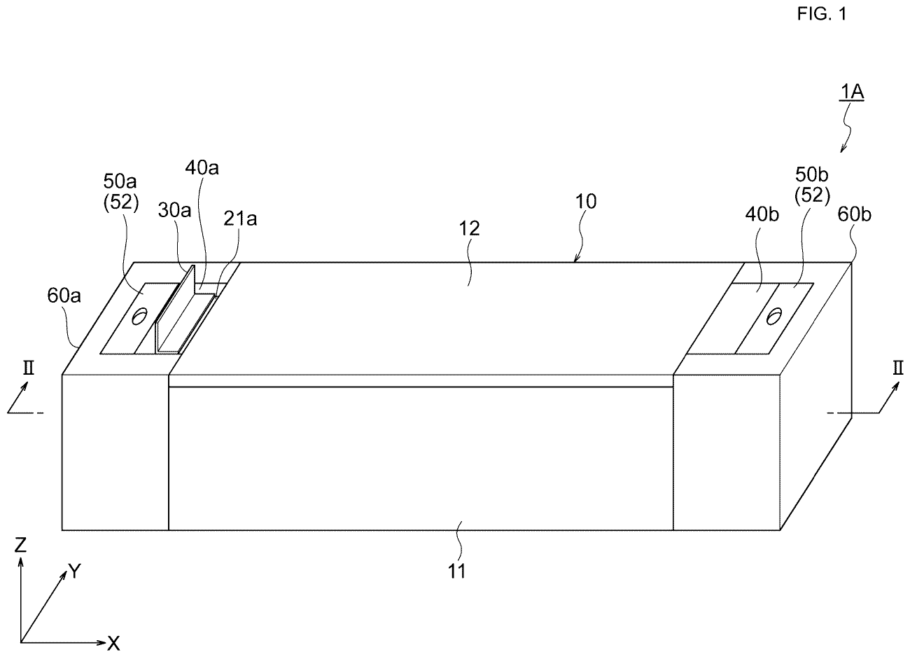

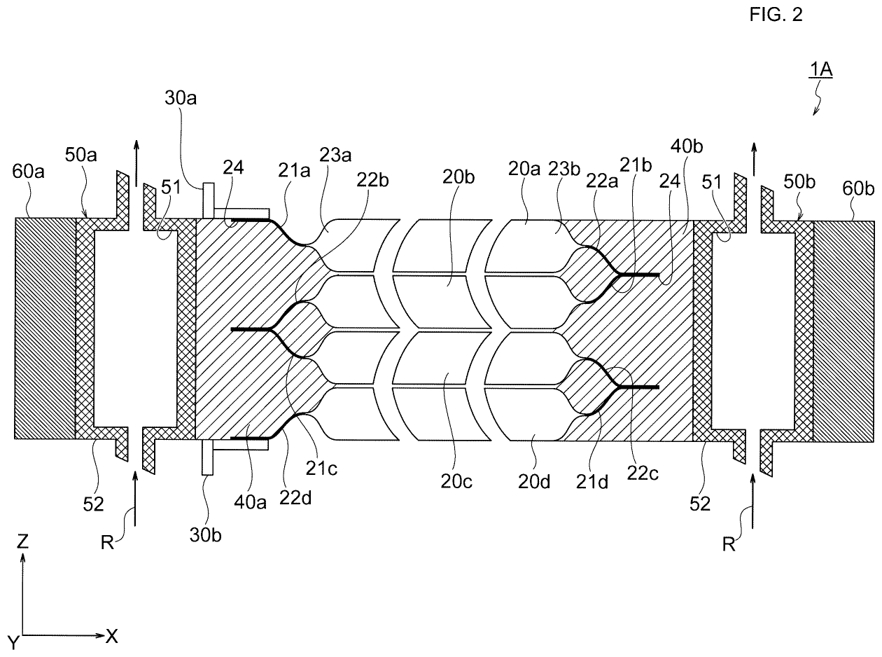

A battery module 1A according to an embodiment will be described based on the drawings. FIG. 1 is a perspective view of an exemplary structure of a battery module 1A according to the embodiment. FIG. 2 is a sectional view taken along the line II-II of FIG. 1.

As illustrated in FIG. 1 and FIG. 2, the battery module 1A according to the embodiment includes a battery case 10, a plurality of battery cells 20a to 20d (see FIG. 2), a pair of busbars 30a, 30b, a pair of heat transfer members 40a, 40b, a pair of cooling jackets 50a, 50b, and a pair of heat insulating members 60a, 60b.

The battery case 10 houses the battery cells 20a to 20d therein. As illustrated in FIG. 1, the battery case 10 includes a case body 11 and a lid member 12. The case body 11 has a box shape having a top end and both side ends opened. The battery cells 20a to 20d are housed inside the case body 11. The lid member 12 closes the opening of the top end of the case body 11.

As illustrated in FIG. 2, the battery cells 20a to 20d each having a flat shape are mutually stacked along a Z direction in the drawing. Each of the battery cells 20a to 20d is a secondary battery such as a lithium-ion secondary battery. Although not specifically illustrated, the secondary battery includes a positive electrode, an electrolyte, and a negative electrode. The electrolyte may be either the liquid electrolyte or the solid electrolyte. Each shape of the battery cells 20a to 20d is not limited to the above-described shape.

The battery cells 20a to 20d further include metallic positive electrode tabs 21a to 21d connected to the positive electrode, and metallic negative electrode tabs 22a to 22d connected to the negative electrode. The positive electrode tabs 21a, 21c and the negative electrode tabs 22b, 22d extend from a first end portion 23a of the battery cells 20a to 20d while the negative electrode tabs 22a, 22c and the positive electrode tabs 21b, 21d extend from a second end portion 23b that is different from the first end portion 23a. The positive electrode tabs 21a to 21d and the negative electrode tabs 22a to 22d are exposed to the battery case 10 from openings at both ends of the case body 11 of the battery case 10.

The positive electrode tab 21a of the battery cell 20a is connected to the metallic busbar 30a by welding or the like. One principal surface (lower surface in this example) of the positive electrode tab 21a is in contact with the heat transfer member 40a while the other principal surface (upper surface in this example) of the positive electrode tab 21a is exposed from the heat transfer member 40a.

The negative electrode tab 22a of the battery cell 20a and the positive electrode tab 21b of the battery cell 20b are embedded in the heat transfer member 40b, and mutually connected by welding or the like. The negative electrode tab 22b of the battery cell 20b and the positive electrode tab 21c of the battery cell 20c are embedded in the heat transfer member 40a, and mutually connected by welding or the like. The negative electrode tab 22c of the battery cell 20c and the positive electrode tab 21d of the battery cell 20d are embedded in the heat transfer member 40b, and mutually connected by welding or the like.

The negative electrode tab 22d of the battery cell 20d is connected to the metallic busbar 30b by welding or the like. One principal surface (upper surface in this example) of the negative electrode tab 22d is in contact with the heat transfer member 40a while the other principal surface (lower surface in this example) of the negative electrode tab 22d is exposed from the heat transfer member 40a.

As described above, in this embodiment, the mutually stacked battery cells 20a to 20d are electrically connected in series. The busbars 30a, 30b are connected to a top end and a bottom end of the stack, respectively. The battery cells 20a to 20d do not have to be electrically connected in series and may be connected in parallel. In this embodiment, the positive electrode tabs 21b to 21d and the negative electrode tabs 22a to 22c are mutually connected directly, but this is not limited thereto, and they may be electrically connected via a busbar.

The heat transfer members 40a, 40b cover both side surfaces of the battery cells 20a to 20d as well as peripheries of the positive electrode tabs 21a to 21d and the negative electrode tabs 22a to 22d. In this embodiment, widths of the heat transfer members 40a, 40b are smaller than widths of the first and the second end portions 23a, 23b of the battery cells 20a to 20d.

The heat transfer members 40a, 40b are each constituted of a member having an electric insulating property and a relatively high thermal conductivity. The thermal conductivities of the heat transfer members 40a, 40b may be, for example, in the range from 1 to 10 W/mK. For example, the heat transfer members 40a, 40b can be formed onto side surfaces of the battery cells 20a to 20d using a filler containing resin. Fibrous or particle-like silicon may be exemplified as the filler.

In this embodiment, the heat transfer member 40a is in contact with the busbars 30a, 30b. In this embodiment, principal surfaces of the busbars 30a, 30b are partially in contact with the heat transfer member 40a, but this is not limited thereto, and the busbars 30a, 30b may be partially embedded in the heat transfer member 40a.

A pair of cooling jackets 50a, 50b are disposed outside the heat transfer members 40a, 40b, respectively. As illustrated in FIG. 1, the cooling jacket 50a has a rectangular parallelepiped shape having substantially the same width as that of the heat transfer member 40a, and is in surface contact with the heat transfer member 40a. Similarly, the cooling jacket 50b has substantially the same width as that of the heat transfer member 40b, and is in surface contact with the heat transfer member 40b. The cooling jackets 50a, 50b in this embodiment correspond to an example of the “first cooling jacket” in the present invention.

The cooling jackets 50a, 50b constitute a cooling source for cooling the battery cells 20a to 20d via the heat transfer members 40a, 40b. The cooling jackets 50a, 50b are constituted of a laminate film or the like including an insulating layer and a metal layer, for example. In this case, the insulating layer such as a resin layer may be formed on the surface of the metal layer.

The cooling jackets 50a, 50b each include an internal space 51 in which a coolant R flows. The coolant of arbitrary type may be used, for example, liquid, gas, or whatever, so long as it is formed as a fluid capable of cooling the battery cells 20a to 20d.

The cooling jackets 50a, 50b in this embodiment include respective parallel portions 52, 52 extending along a first direction that is substantially parallel to a stacking direction (Z direction in the drawing) of the battery cells 20a to 20d. The internal space 51 along the parallel portion 52 extends in the first direction to allow the coolant R to flow along the first direction. The cooling jackets 50a, 50b may be connected to a not shown device, such as a pump and a radiator, via the flow passage.

Heat insulating members 60a, 60b are disposed outside the parallel portions 52 of the cooling jackets 50a, 50b, respectively. In this embodiment, the heat insulating members 60a, 60b cover outer surfaces of the heat transfer members 40a, 40b and the cooling jackets 50a, 50b, respectively. The heat insulating members 60a, 60b are shaped along the outer surfaces of the heat transfer members 40a, 40b and the cooling jackets 50a, 50b, respectively. In this embodiment, the heat insulating member has a U-like shape in a plan view, and is curved to project to the outside of the battery module 1A.

The heat insulating members 60a, 60b are constituted of a material with a heat insulating property. As the material with a heat insulating property, a resin material with a heat insulating property, which is not specifically limited thereto, can be exemplified. More specifically, as the resin material with a heat insulating property, a foamed resin such as a urethane foam can be exemplified. The heat insulating members 60a, 60b allow the heat transferred from the positive/negative electrode tabs 21a to 21d, 22a to 22d to be concentrated on the cooling jackets 50a, 50b, thus improving the heat removing effect.

The battery module 1A according to the embodiment covers peripheries of the positive/negative electrode tabs 21a to 21d, 22a to 22d of the battery cells 20a to 20d by the heat transfer members 40a, 40b, and brings the cooling jackets 50a, 50b into contact with the heat transfer members 40a, 40b. This makes it possible to improve the heat transfer efficiency between the positive/negative electrode tabs 21a to 21d, 22a to 22d, and the heat transfer members 40a, 40b, and improve the cooling efficiency (heat removing effect) of the battery cells 20a to 20d.

The battery module 1A allows improvement in the cooling efficiency by the heat transfer members 40a, 40b to eliminate the need of increasing the size of the cooling mechanism such as the cooling jackets 50a, 50b, resulting in energy saving effect. As a result, this makes it possible to satisfy requirements of the volume energy density, weight energy density, power amount, and cost.

Especially, in this embodiment, the heat transfer members 40a, 40b are in contact with the positive/negative electrode tabs 21a to 21d, 22a to 22d three-dimensionally to improve the heat transfer efficiency between the heat transfer members 40a, 40b and the positive/negative electrode tabs 21a to 21d, 22a to 22d. This allows improvement in the cooling efficiency of the battery cells 20a to 20d.

In this embodiment, a main part (stacked part of the electrode) of the battery cells 20a to 20d is not directly cooled, but the positive/negative electrode tabs 21a to 21d, 22a to 22d are cooled. According to the inventor's knowledge, the positive/negative electrode tabs 21a to 21d, 22a to 22d are more likely to be in the high-temperature state than the main part of the battery cells 20a to 20d. The battery module 1A according to this embodiment allows reduction in the risk caused by temperature rise of the positive/negative electrode tabs 21a to 21d, 22a to 22d.

The above-described embodiment has been described with respect to the case where each of the cooling jackets 50a, 50b includes the parallel portion 52 extending in the first direction (Z direction in the drawing), but the invention is not limited thereto. For example, cooling jackets 50c, 50d may have vertical portions 53a to 53e extending along a second direction that is substantially perpendicular to the first direction as described in a first modification below.

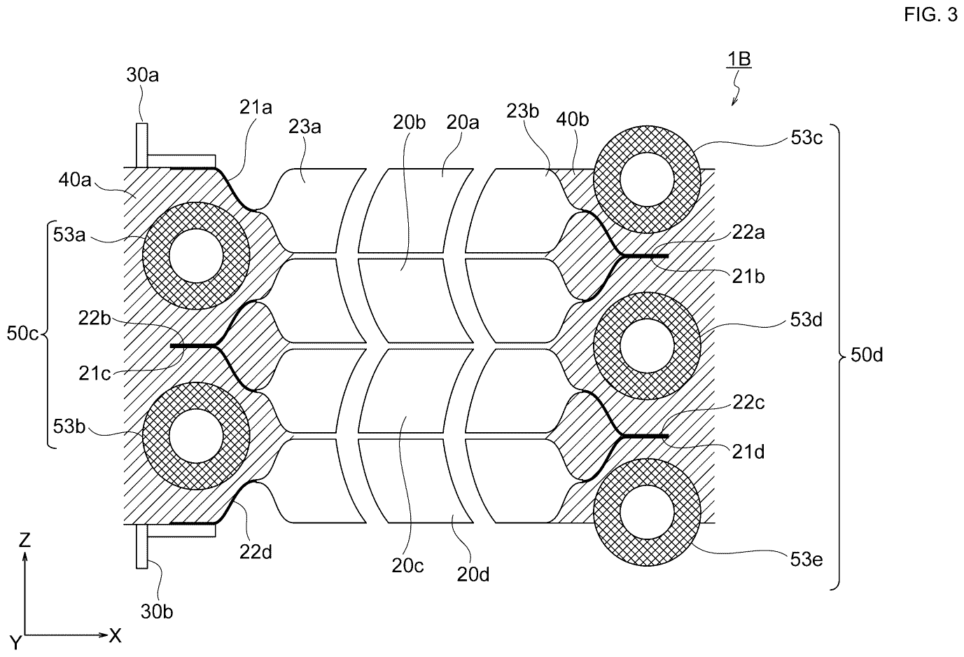

FIG. 3 is a sectional view illustrating an exemplary structure of a battery module 1B according to the first modification. As illustrated in FIG. 3, the battery module 1B according to the modification is different from the battery module 1A according to the above-described embodiment in that (1) the cooling jackets 50c, 50d include the vertical portions 53a to 53e extending along the second direction (Y direction in the drawing) compared with the battery module 1A of the above-described embodiment. Structures except those described above are similar to those of the above-described embodiment. The battery module 1B according to the first modification will be described with respect only to the difference from the above-described embodiment. The same reference numerals are given to the same structures as those of the above-described embodiment to omit description of the structure.

In the first modification, the cooling jacket 50c includes the tubular vertical portions 53a, 53b. The vertical portions 53a, 53b extend along the second direction (Y direction in the drawing). The vertical portion 53a is embedded in the heat transfer member 40a so as to be positioned between the positive electrode tab 21a and the negative electrode tab 22b. Meanwhile, the vertical portion 53b is embedded in the heat transfer member 40a so as to be positioned between the positive electrode tab 21c and the negative electrode tab 22d. Although not specifically illustrated, the cooling jacket 50c has a meandering shape having the above-mentioned vertical portions 53a, 53b positioned between the positive electrode tab 21a and the negative electrode tab 22b, and between the positive electrode tab 21c and the negative electrode tab 22d, respectively. The vertical portions 53a, 53b are mutually connected via a curved portion of the meandering shape. The vertical portions 53a and 53b may be provided as separate bodies.

The cooling jacket 50d includes the tubular vertical portions 53c to 53e. The vertical portions 53c to 53e also extend along the second direction (Y direction in the drawing). The vertical portion 53c is positioned above the negative electrode tab 22a, and the vertical portion 53c is partially exposed from the heat transfer member 40b. Meanwhile, the vertical portion 53d is embedded in the heat transfer member 40b so as to be positioned between the positive electrode tab 21b and the negative electrode tab 22c. The vertical portion 53e is positioned below the positive electrode tab 21d, and the vertical portion 53e is partially exposed from the heat transfer member 40b. Although not specifically illustrated, the cooling jacket 50d also has the meandering shape, and the vertical portions 53c to 53e are mutually connected via the curved portion of the meandering shape. The vertical portions 53c to 53e may be provided as separate bodies.

The battery module 1B according to the first modification also allows improvement in the cooling efficiency like the battery module 1A according to the above-described embodiment.

Especially, in this modification, the cooling jackets 50c, 50d are embedded in the heat transfer members 40a, 40b. This makes it possible to reduce the distance between the cooling jackets 50c, 50d and the positive/negative electrode tabs 21a to 21d, 22a to 22d. This allows improvement in the cooling efficiency.

The above-described embodiment has been described with respect to the case where the cooling jackets 50a, 50b are disposed only at sides of distal ends 24 of the positive/negative electrode tabs 21a to 21d, 22a to 22d, but the invention is not limited thereto. For example, cooling jackets 50e to 50h may further be provided as described in a second modification below.

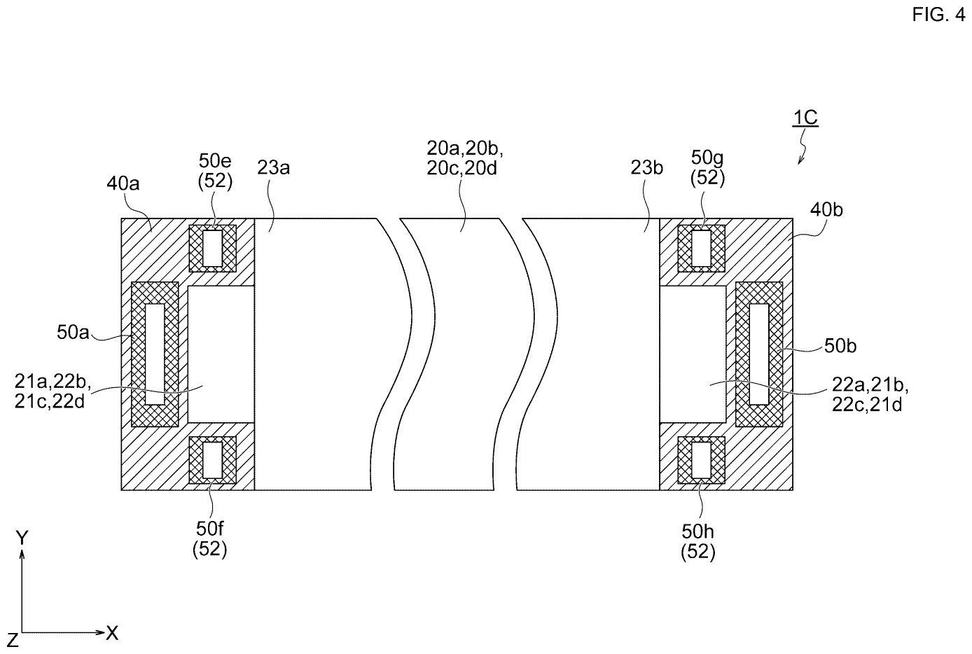

FIG. 4 is a plan view illustrating an exemplary structure of a battery module 1C according to the second modification. The battery module 1C according to the second modification will be described with respect only to the difference from the battery module 1A according to the above-described embodiment. The same reference numerals are given to the same structures as those of the battery module 1A to omit description of the structure.

In the second modification, the cooling jackets 50e, 50f are disposed at both sides of the positive/negative electrode tabs 21a, 22b, 21c, 22d along the first end portion 23a of the battery cells 20a to 20d. The cooling jackets 50e, 50f include the parallel portion 52 like the above-described embodiment. The parallel portions 52 of the cooling jackets 50e, 50f have a width corresponding to respective side surfaces of the positive/negative electrode tabs 21a, 22b, 21c, 22d. The width is narrower than that of the parallel portion 52 of the cooling jacket 50a.

Similarly, the cooling jackets 50g, 50h are disposed at both sides of the positive/negative electrode tabs 22a, 21b, 22c, 21d along the second end portion 23b of the battery cells 20a to 20d. The cooling jackets 50g, 50h also include the parallel portion 52 like the cooling jackets 50e, 50f.

In this embodiment, the cooling jackets 50a, 50b, 50e to 50h are embedded in the heat transfer members 40a, 40b, respectively, but are not limited to the structure. They may be brought into contact with the heat transfer members 40a, 40b from outside.

The battery module 1C according to the second modification allows improvement in the cooling efficiency like the battery module 1A according to the above-described embodiment. Especially, in this modification, the number of cooling jackets is increased to allow further improvement in the cooling efficiency.

The above-described embodiment has been described with respect to the case where the positive/negative electrode tabs extend from the first and the second end portions, but the invention is not limited thereto. The positive/negative electrode tabs may be structured to extend from the same end portion (the second end portion 23b in this modification) as described in a third modification below.

In this case, the cooling jacket 50a is also embedded in the heat transfer member 40b in contact therewith. In the third modification, cooling jackets 50i, 50j are disposed at both sides of the positive/negative electrode tabs 21a, 22b, 21c, 22d, and cooling jackets 50j, 50k are disposed at both sides of the positive/negative electrode tabs 22a, 21b, 22c, 21d. The cooling jackets 50i to 50k according to this modification are structured similarly to the cooling jackets 50e to 50h according to the second modification.

A battery module 1D according to the third modification allows improvement in the cooling efficiency like the battery module 1A according to the above-described embodiment. Especially, also in the modification, the number of cooling jackets is increased to allow further improvement in the cooling efficiency like the second modification.

### DESCRIPTION OF REFERENCE NUMERALS

1A battery module
10 battery case
11 case body
12 lid member
20a to 20d battery cell
21a to 21d positive electrode tab
22a to 22d negative electrode tab
23a, 23b first/second end portion
24 distal end
30a, 30b busbar
40a, 40b heat transfer member
50a to 50d cooling jacket
51 internal space
52 parallel portion
53a to 53d vertical portion
60a, 60b heat insulating member
R coolant

1. A battery module comprising:
battery cells that are mutually stacked;
a heat transfer member having an electric insulating property and being in direct contact with peripheries of tabs of the battery cells and covering the peripheries of the tabs; and
a cooling jacket having an internal space in which a coolant flows and being in contact with the heat transfer member, and wherein
the tabs include a distal end surface and a peripheral surface,
the heat transfer member is in direct contact with the distal end surface and the peripheral surface.

2. The battery module according to claim 1, wherein
the cooling jacket has a parallel portion extending along a first direction substantially parallel to a stacking direction of the battery cells, and
the coolant flows along the first direction in the parallel portion.

3. The battery module according to claim 1, wherein
the cooling jacket has a vertical portion extending along a second direction substantially perpendicular to a stacking direction of the battery cells, and
the coolant flows along the second direction in the vertical portion.

4. The battery module according to claim 2, wherein the cooling jacket is disposed outside the heat transfer member.

5. The battery module according to claim 2, wherein the cooling jacket is embedded in the heat transfer member.

6. The battery module according to claim 5, wherein the cooling jacket is disposed between the tabs.

7. The battery module according to claim 1, wherein
the tabs includes a positive electrode tab and a negative electrode tab, and
the positive electrode tab and the negative electrode tab extend from a same end portion of the battery cell, or extend from different end portions of the battery cell.

8. The battery module according to claim 7, wherein the cooling jacket includes a first cooling jacket disposed at a side of a distal end of the tab.

9. The battery module according to claim 7, wherein the cooling jacket includes second cooling jackets disposed on respective both sides of the tab along the end portion in a second direction substantially perpendicular to a stacking direction of the battery cells.

10. The battery module according to claim 1, further comprising a heat insulating member that covers the cooling jacket.

11. The battery module according to claim 1, wherein the tabs are embedded in the heat transfer member.
